(19) United States
(12) Patent Application Publication
(10) Pub. No.: US 2019/0371039 A1
(43) Pub. Date: Dec. 5, 2019

(54) METHOD AND SMART TERMINAL FOR SWITCHING EXPRESSION OF SMART TERMINAL

(71) Applicant: UBTECH ROBOTICS CORP., Shenzhen (CN)

(72) Inventors: Youjun XIONG, Shenzhen (CN); Ding PENG, Shenzhen (CN)

(21) Appl. No.: 16/231,961

(22) Filed: Dec. 25, 2018

(30) Foreign Application Priority Data
Jun. 5, 2018 (CN) 201810568631.1

(51) Int. Cl. G06T 13/80

(52) U.S. Cl. CPC G06T 13/80

(57) ABSTRACT

A method for switching expression of a smart terminal is provided. The smart terminal displays different expression animations to express different expressions. The method includes determining whether a play process of a current expression is interrupted when receiving a request for expression conversion; and deriving interim data based on the current expression and a request expression, and playing the request expression after rendering the interim data when the play process of the current expression is interrupted; otherwise, playing the request expression directly.

### CROSS REFERENCE TO RELATED APPLICATIONS

The present disclosure claims a priority to Chinese Patent Application No. 201810568631.1, filed on Jun. 5, 2018, the entire contents of which are hereby incorporated by reference in its entirety.

### TECHNICAL FIELD

The present disclosure relates to animation technology, and in particular to method for switching expression of a smart terminal and a smart terminal.

### BACKGROUND

With the development of artificial intelligence technology, displaying various animation expressions on a smart device using display technology has become more and more widespread, for example, an intelligent robot that simulates human facial expressions and emotional movements. Generally, expressions are represented in an animated form, and different expressions correspond to different animations. The traditional method for animation design is to draw each frame of images with expressions and movements, and achieve continuous animation effect through continuous playback. However, a phenomenon that the images are changed suddenly is likely to occur when different expressions are switched in the related art, which affects the display effect.

### SUMMARY OF THE DISCLOSURE

According to one aspect of the present disclosure, a method for switching expression of a smart terminal is provided. The smart terminal displays different expression animations to express different expressions. The method includes determining whether a play process of a current expression is interrupted when receiving a request for expression conversion; and deriving interim data based on the current expression and a request expression, and playing the request expression after rendering the interim data when the play process of the current expression is interrupted; otherwise, playing the request expression directly.

According to another aspect of the present disclosure, a smart terminal is provided. The smart terminal displays different expression animations to express different expressions and includes a processor and a memory storing computer programs. The computer programs, when executed by the processor, cause the processor to determine whether a play process of a current expression is interrupted when receiving a request for expression conversion; and derive interim data based on the current expression and a request expression, and plays the request expression after rendering the interim data when the play process of the current expression is interrupted; otherwise, play the request expression directly.

According to yet another aspect of the present disclosure, a non-transitory computer readable medium is provided, which stores computer programs. The computer programs, when executed by a processor, cause the processor to perform a method for switching expression of a smart terminal. The smart terminal displays different expression animations to express different expressions, and the method includes determining whether a play process of a current expression is interrupted when receiving a request for expression conversion; and deriving interim data based on the current expression and a request expression, and playing the request expression after rendering the interim data when the play process of the current expression is interrupted; otherwise, playing the request expression directly.

### BRIEF DESCRIPTION OF THE DRAWINGS

In order to more clearly illustrate the technical solutions in embodiments of the present disclosure, the drawings used in the embodiments or the description of the related art will be briefly described below. It is obvious that the drawings in the following are only some embodiments of the present disclosure. For those ordinary skilled in the art, other drawings may be obtained from those drawings without creative works.

FIG. 1 is a flowchart of a method for switching expression of a smart terminal according to an embodiment of the present disclosure;

FIG. 2 is a flowchart of an implementation process of block 102 in FIG. 1 according to an embodiment of the present disclosure;

FIG. 3 is a schematic diagram of a system for switching expression according to an embodiment of the present disclosure;

FIG. 4 is a schematic diagram of a first execution module in FIG. 3 according to an embodiment of the present disclosure; and

FIG. 5 is a schematic diagram of a smart terminal according to an embodiment of the present disclosure.

### DETAILED DESCRIPTION

In the following, specific details such as a specified system structure and technology are proposed for purposes of illustration instead of limitation. However, it will be apparent to those skilled in the art that the present disclosure may be practiced in other embodiments without these specific details. In other instances, detailed descriptions of well-known systems, devices, circuits, and methods are omitted so as not to obscure the description of the present disclosure.

The term “comprise” and any other variations thereof in the specification and claims of the present disclosure and the above-mentioned drawings mean “include but not limited to”, and is intended to cover non-exclusive inclusion. For example, a process, method or system, product or device comprising a series of steps or units is not limited to the listed steps or units, but optionally they also include steps or units not listed herein, or alternatively they also include other steps or units inherent to these processes, methods, products or device. Moreover, the terms “first”, “second”, and “third”, etc. are used to distinguish different objects, and are not intended to describe a particular order.

In order to illustrate the technical solutions described in the present disclosure, the following description will be made by way of specific embodiments.

### Embodiment I

FIG. 1 is a flowchart of a method for switching expression according to an embodiment of the present disclosure. For convenience of description, only parts related to the embodiment of the present disclosure are shown, which are described in detail as follows.

As shown in FIG. 1, the method for switching expression provided by an embodiment of the present disclosure includes the following actions/operations in the following blocks.

At block 101, whether a play process a current expression is interrupted is determined when receiving a request for expression conversion.

The embodiments of the present disclosure may be applied to smart terminals, including smart robots, mobile phones, or computers. The smart terminal may display different expression animations to express different expressions.

In this embodiment, when the smart terminal simulates displaying a human facial expression or an emotional motion, the smart terminal receives a request for expression conversion and then performs an expression conversion to switch to another expression.

The request for expression conversion may be an external request instruction input by a user, or may be an internal request instruction generated by the internal code operation.

The current expression is an expression that the smart terminal is currently playing when receiving the request for expression conversion.

In this embodiment, whether the current expression is interrupted is used to indicate whether the current expression has been played. If the current expression has been played, meaning that the current expression has not been interrupted, it indicates that the current expression displayed in the smart terminal may be restored to be static, and a next expression which may be requested can be directly played. If the current expression has not been played, meaning that the current expression is interrupted, it indicates that the current expression displayed in the smart terminal is dynamic at this time, and a transitional method is needed to avoid the sudden change of the expression animation of the current expression. Thus, the display effect and the user experience may be improved.

In an embodiment of the present disclosure, at the block 101, determining whether the play process of the current expression is interrupted includes the following actions. 1) The current frame of an expression animation of the current expression at an interruption time where the play process of the current expression is interrupted may be obtained. 2) An end frame of the expression animation of the current expression may be obtained. 3) Whether the current frame is same to the end frame may be detected. 4) It is determined that the play process of the current expression is interrupted if the current frame is not same to the end frame. 5) It is determined that the play process of the current expression is uninterrupted if the current frame is same to the end frame.

In this embodiment, the interruption time is the time when the request for expression conversion is received.

An expression animation may include a number of frames of images that are played continuously in a predetermined order. These frames may include a starting frame as the first frame, middle frames, and an end frame as the last frame. The frame data of each expression is stored in advance in the smart terminal. In this embodiment, the current frame is the frame data what is being played at the interruption time when the current expression is played. The end frame is the last frame of the current expression.

In this embodiment, it is determined whether the play process of the current expression is played by detecting whether the current fame is same to the end frame. If the current frame is un-same to the end frame, it means that the play process of the current expression is interrupted and is not played completely. If the current frame is same to the end frame, it indicates that the play process of the current expression has been performed completely, meaning that the play process is not interrupted and is played completely.

At block 102, interim data may be derived based on the current expression and a request expression, and the request expression may be played after the interim data is rendered when the play process of the current expression is interrupted.

In this embodiment, the request expression corresponds to the request for expression conversion.

In one embodiment of the present disclosure, the play process of the current expression is stopped to be played after the play process of the current expression is interrupted.

In this embodiment, after receiving the request for expression conversion, the smart terminal needs a natural gradient to a next expression while the previous expression is interrupted. The interrupted expression can be naturally switched to the next expression through deriving and rendering the interim data, which makes expression more realistic and expressive.

At block 103, the request expression is directly played when the play process of the current expression is not interrupted.

The interim data is inserted when an expression is interrupted in an embodiment of the present disclosure. Thus, the function of a system for rendering expression system may be enhanced, and the display effect and the user experience may be improved.

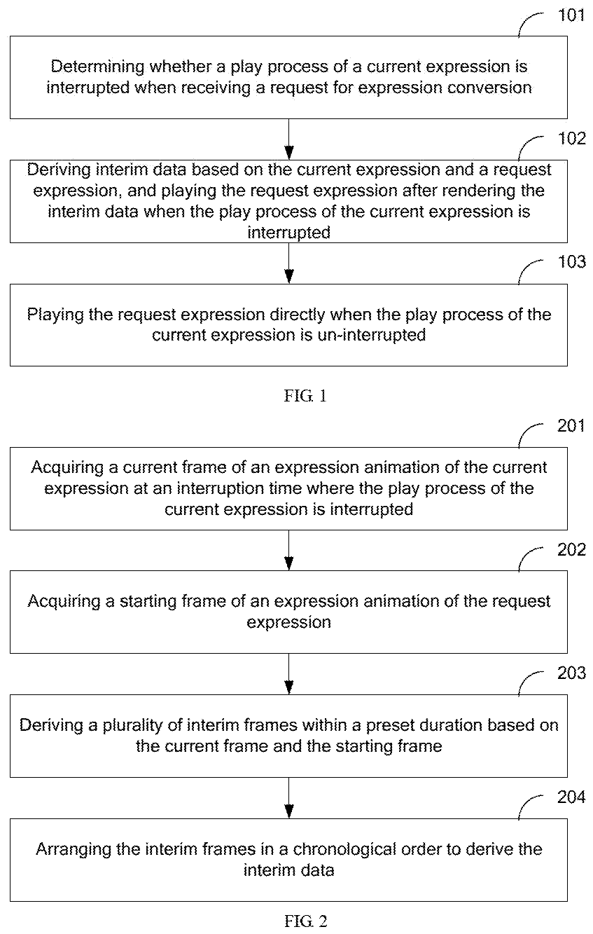

As shown in FIG. 2, in an embodiment of the present disclosure, at the block 102, deriving the interim data based on the current expression and the request expression may include the following actions/operations in the following blocks.

At block 201, a current frame at the interruption time may be acquired.

At block 202, a starting frame of the request expression may be acquired.

At block 203, a plurality of interim frames within a preset duration may be derived based on the current frame and the starting frame.

At block 204, all the interim frames may be arranged in a chronological order such that the interim data may be acquired.

In this embodiment, the starting frame is the first frame data of the request expression. The current flame is used as a starting key frame, and the starting frame of the request expression is used as an end key frame. The frames located between the starting key frame and the end key frame is derived as the interim frames. An image for the interim frames can be generated by an image algorithm, which includes a matrix operation, cubic curve drawing, layer drawing, and the like.

In an embodiment of the present disclosure, the block 203 includes the following operations. 1) Dimension parameters in the current frame may be acquired, which may be used as a first set of dimension parameters. 2) Dimension parameters in the starting frame may be acquired, which may be used as a second set of dimension parameters. 3) The dimension parameters in the current frame may be compared with the dimension parameters in the starting frame to record parameters that are different in the current frame and the starting frame. 4) Key frames corresponding to the parameters that are different in the current frame and the starting frame may be constructed. 5) The key frames may be inserted between the current frame and the starting frame. 6) Interim frames among the key frames may be created based on the preset duration and a frame rate of the expression animation of the current expression.

In an embodiment of the present disclosure, the dimension parameters include a shape parameter, a color parameter, a transparency parameter, a position parameter, and a scaling parameter of each expression component.

In this embodiment, an expression consists of a plurality of facial organ expressions, which are used for simulating a human face, and each facial organ is composed of a plurality of expression components. Taking an eye expression as an example, expression components of an eye include basic expression components such as white, upper eyelid, lower eyelid, lens, iris, and the like. Each expression component includes data of various dimensions such as shape parameter, color parameter, transparency parameter, position parameter, and scaling parameter.

The dimension parameters in the current frame may be compared with the dimension parameters in the starting frame, and then the parameters which are different may be obtained. Key frames corresponding to the parameters which are different may be derived by an image algorithm, and then interim frames among key frames may be created based on an interpolation algorithm. Interim frames can be created in a uniform, accelerated or decelerated manner.

A specific application scenario where a closed-eye expression is switched to a blinking expression may be taken as an example.

The current expression is a closed-eye expression. An expression processing is performed half when receiving a request for expression conversion, and then the current frame is a frame where the upper eyelid is located in the middle of the eyeball, and the starting frame of the request expression is a frame where the upper eyelid is located at the lower end of the eyeball.

In this application scenario, the current frame is used as a starting key frame, the starting frame of the request expression is used as an end key frame, the interim time from the starting key frame to the end key frame is preset to be 1 s, and the frame rate of the expression animation is 30 frames per second. The difference about the position parameters of the upper eyelid component may be acquired, and a curve of the difference of the position parameters may be smoothed using a curve drawing algorithm. It is necessary to insert 28 interim frames as is known from the frame rate. 28 interpolation points may be acquired from the drawn smoothed curve, and then interim frames may be created, which correspond these interpolation points. That is, for the current expression, a number of the interim frames is derived by the preset duration and a frame rate of the expression animation of the current expression.

In this embodiment of the present disclosure, during an expression is rendered by the computer software, the smart terminal receives a request for a new expression, which is triggered by an external condition. At this time, a previous expression is interrupted, and a next expression is required to be naturally gradient. In this scheme, an interpolation process is performed on parameters of the eye components such as the shape parameters, color parameters, transparency parameters, position parameters, scaling parameters, etc. The eye shape at a certain moment after the interruption is naturally switched to a next form. Thus, the expression simulated and displayed by the smart terminal become more realistic and more expressive.

It should be understood that the sequence of the blocks in the above embodiments does not mean that the order that those blocks are performed. The execution order of each processing should be determined by its function and internal logic, and should not be construed as limiting the implementation process of the embodiments of the present disclosure.

### Embodiment II

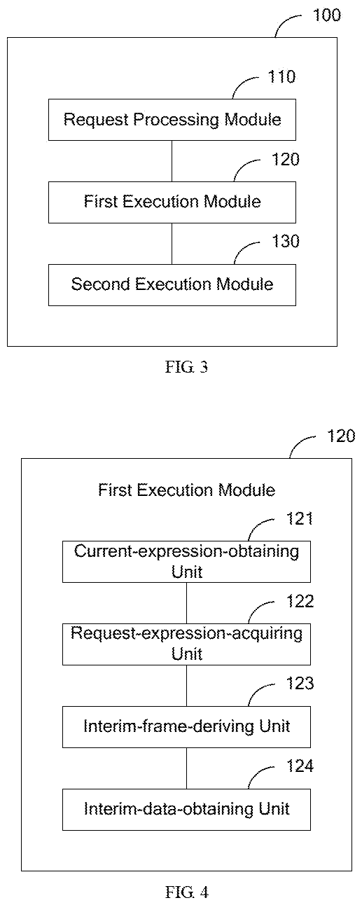

As shown in FIG. 3, an expression switch system 100 is provided in an embodiment of the present disclosure, which is configured to perform operations in the blocks in the method of FIG. 1. The expression switch system may include a request processing module 110, a first execution module 120, and a second execution module 130.

The request processing module 110 is configured to determine whether a play process of the current expression is interrupted when a request for expression conversion is received.

The first execution module 120 is configured to derive interim data based on the current expression and a request expression and play the request expression after the interim data is rendered when the play process of the current expression is interrupted.

The second execution module 130 is configured to directly play the request expression when the play process of the current expression is not interrupted.

In one embodiment of the present disclosure, the current expression is stopped after the play process of the current expression is interrupted.

In one embodiment of the present disclosure, the request processing module 110 includes a first frame acquiring unit, a second frame acquiring unit, a comparing unit, a first determining unit, and a second determining unit.

The first frame acquiring unit is configured to acquire a current frame of an expression animation of the current expression at an interruption time where the play process of the current expression is interrupted.

The second frame acquiring unit is configured to acquire an end frame of the expression animation of the current expression.

The comparing unit is configured to detect whether the current frame is same to the end frame.

The first determining unit is configured to determine that the play process of the current expression is interrupted when the current frame is not same to the end frame.

The second determining unit is configured to determine that the play process of the current expression is not interrupted when the current frame is same to the end frame.

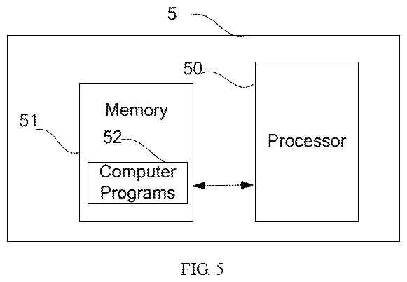

As shown in FIG. 4, in an embodiment of the present disclosure, the first execution module 120 in the embodiment of FIG. 3 further includes a structure for performing the method in the embodiment of FIG. 2, which includes a current-expression-obtaining unit 121, a request-expression-acquiring unit 122, interim-frame-deriving unit 123, and interim-data-obtaining unit 124.

The current-expression-obtaining unit 121 is configured to acquire a current frame of an expression animation of the current expression at an interruption time where the play process of the current expression is interrupted.

The request-expression-acquiring unit 122 is configured to acquire a starting frame an expression animation of the request expression.

The interim-frame-deriving unit 123 is configured to deriving interim frames within a preset duration based on the current frame and the starting frame.

The interim-data-obtaining unit 124 is configured to arrange all the interim frames in a chronological order to obtain the interim data.

In an embodiment of the present disclosure, the interim frame deriving unit 123 is further configured to obtain dimension parameters in the current frame, which are used as a first set of dimension parameters, obtain dimension parameters in the starting frame, which are used as a second set of dimension parameters, compare the first set of dimension parameters with the second set of dimension parameters to record parameters which are different, acquire key frames corresponding to the parameters which are different, insert the key frames between the current frame and the starting frame, and create interim frames among key frames based on the preset duration and a frame rate of the expression animation.

In one embodiment, the expression switch system 100 further includes other functional modules/units for implementing the method in the various embodiments of the Embodiment I.

### Embodiment III

FIG. 5 is a schematic diagram of a smart terminal according to an embodiment of the present disclosure. As shown in FIG. 5, the smart terminal 5 includes a processor 50, a memory 51, and a computer program 52 stored in the memory 51 and executable on the processor 50 in this embodiment. The processor 50 implements actions/operation in the blocks of the various examples as described in the Embodiment I when executing the computer program 52, such as the blocks 101-103 shown in FIG. 1. Alternatively, when the processor 50 executes the computer program 52, the functions of the modules/units in the system of various embodiments as described in Embodiment II are implemented, such as the functions of the modules 110-130 shown in FIG. 3.

The smart terminal 5 may be a smart robot and a computing device such as a desktop computer, a notebook, a palmtop computer or a cloud server. The smart terminal may include, but is not limited to, a processor 50 and a memory 51. It will be appreciated by those skilled in the art that FIG. 5 is only an example of the smart terminal 5, without constituting a limitation of the smart terminal 5, and it may include more or less components than what are illustrated, or combine some components or different components. For example, the smart terminal 5 may further include an input/output device, a network access device, a bus, and the like.

The processor 50 may be a central processing unit (CPU), or may be a general-purpose processor, a digital signal processor (DSP), an application specific integrated circuit (ASIC), a Field-Programmable Gate Array (FPGA) or other programmable logic device, a discrete gate or transistor logic device, discrete hardware components, etc. The general-purpose processor may be a microprocessor, or the processor may be any conventional processor.

The memory 51 can be an internal storage unit in the smart terminal 5, such as a hard disk or a memory of the smart terminal 5. The memory 51 may also be an external storage device of the smart terminal 5, such as a plug-in hard disk equipped on the smart terminal 5, a smart memory card (SMC), and a secure digital (SD). Card, flash card, etc. Further, the memory 51 may include both an internal storage unit of the smart terminal 5 and an external storage device. The memory 51 is used for storing the computer program and other programs and data required by the smart terminal 5. The memory 51 can also be used for temporarily storing data that has been output or is about to be output.

### Embodiment IV

A non-transitory computer readable storage medium is also provided in an embodiment of the present disclosure. The non-transitory computer readable storage medium stores computer programs. When the computer programs are executed by a processor, the actions/operations in blocks in the embodiments as described in Embodiment I are implemented, for example, the actions/operations in blocks 101-103 shown in FIG. 1. Alternatively, the functions of the modules/units in the system of various embodiments as described in Embodiment II are implemented when the computer programs are executed by the processor, such as the functions of the modules 110-130 shown in FIG. 3.

The computer programs can be stored in a non-transitory computer readable storage medium, which, when executed by a processor, can implement the actions/operations in blocks in the method of various embodiments described above. The computer programs may include computer program code, which may be source code, object code, executable file or some intermediate form. The non-transitory computer readable medium may include any entity or device capable of carrying the computer program code, a recording medium, a USB flash drive, a removable hard disk, a magnetic disk, an optical disk, a computer memory, a read-only memory (ROM), a random access memory (RAM), electrical carrier signals, telecommunications signals, and software distribution media. It should be noted that the content contained in the computer readable medium may be appropriately increased or decreased according to the requirements of legislation and patent practice in a jurisdiction. For example, in some jurisdictions, according to legislation and patent practice, computer readable media does not include electrical carrier signals and telecommunication signals.

In the above embodiments, the descriptions of the various embodiments are different, and the parts that are not detailed or described in a certain embodiment can be referred to the related descriptions of other embodiments.

The blocks in the method of the embodiment of the present disclosure may be sequentially adjusted, merged, and deleted according to actual needs.

Modules or units in the system of the embodiments of the present disclosure may be combined, divided, and deleted according to actual requirements.

Those of ordinary skill in the art will appreciate that the elements and algorithm steps of the various examples described in connection with the embodiments disclosed herein can be implemented in electronic hardware or a combination of computer software and electronic hardware. Whether these functions are performed in hardware or software depends on the specific application and design constraints of the solution. A person skilled in the art can use different methods for implementing the described functions for each particular application, but such implementation should not be considered to be beyond the scope of the present disclosure.

In the embodiments provided by the present disclosure, it should be understood that the disclosed system/smart terminal and method may be implemented in other manners. For example, the system/smart terminal embodiment described above is merely illustrative. For example, the division of the module or unit is only a logical function division. In actual implementation, there may be another division manner. For example, multiple units or components may be combined or integrated into another system, or some features may be omitted or not implemented. In addition, the mutual coupling or direct coupling or communication connection shown or discussed herein may be an indirect coupling or communication connection through some interface, device or unit, and may be electrical, mechanical or otherwise.

The embodiments described above are only for explaining the technical solutions of the present disclosure, and are not intended to be limiting. Although the present disclosure has been described in detail with reference to the foregoing embodiments, those skilled in the art will understand that the technical solutions described in the examples are modified, or some of the technical features are equivalently replaced. The modifications or replacement do not deviate from the spirit and scope of the technical solutions of the embodiments of the present disclosure, and should be within the scope of protection of the present disclosure.

What is claimed is:

1. A method for switching expression of a smart terminal, the smart terminal displaying different expression animations to express different expressions, and the method comprising:
determining whether a play process of a current expression is interrupted when receiving a request for expression conversion; and
deriving interim data based on the current expression and a request expression, and playing the request expression after rendering the interim data when the play process of the current expression is interrupted; otherwise, playing the request expression directly.

2. The method of claim 1, wherein the deriving interim data based on the current expression and the request expression, comprises:
acquiring a current frame of an expression animation of the current expression at an interruption time where the play process of the current expression is interrupted;
acquiring a starting frame of an expression animation of the request expression;
deriving a plurality of interim frames within a preset duration based on the current frame and the starting frame; and
arranging the interim frames in a chronological order to derive the interim data.

3. The method of claim 2, wherein the deriving the plurality of interim frames within the preset duration based on the current frame and the starting frame comprises:
acquiring dimension parameters in the current frame:
acquiring dimension parameters in the starting frame;
comparing the dimension parameters in the current frame with the dimension parameters in the starting frame to record parameters that are different in the current frame and the starting frame;
constructing key frames corresponding to the parameters that are different in the current frame and the starting frame;
inserting the key frames between the current frame and the starting frame; and
creating the interim frames among the key frames based on the preset duration and a frame rate of the expression animation of the current expression.

4. The method of claim 3, wherein a number of the interim frames is derived by the preset duration and a frame rate of the expression animation of the current expression.

5. The method of claim 3, wherein the key frames are constructed in a uniform manner.

6. The method of claim 3, wherein the dimension parameters comprise a shape parameter, a color parameter, a transparent parameter, a position parameter, and a scale parameter of an expression element of the expression animation.

7. The method of claim 1, after the play process of the current expression is interrupted, further comprising:
stopping the play process of the current expression.

8. The method of claim 1, wherein the determining whether the play process of a current expression is interrupted comprises:
acquiring a current frame of an expression animation of the current expression at an interruption time where the play process of the current expression is interrupted;
acquiring an end frame of the expression animation of the current expression;
detecting whether the current frame is same to the end frame; and
deciding the play process of the current expression is interrupted when the current frame is not same to the end frame, otherwise deciding the play process of the current expression is uninterrupted.

9. A smart terminal, displaying different expression animations to express different expressions and comprising a processor and a memory storing computer programs, wherein the computer programs, when executed by the processor, cause the processor to:
determine whether a play process of a current expression is interrupted when receiving a request for expression conversion; and
derive interim data based on the current expression and a request expression, and play the request expression after rendering the interim data when the play process of the current expression is interrupted; otherwise, play the request expression directly.

10. The smart terminal of claim 9, wherein the deriving interim data based on the current expression and the request expression, comprises:
acquiring a current frame of an expression animation of the current expression at an interruption time where the play process of the current expression is interrupted;
acquiring a starting frame of an expression animation of the request expression;
deriving a plurality of interim frames within a preset duration based on the current frame and the starting frame; and
arranging the interim frames in a chronological order to derive the interim data.

11. The smart terminal of claim 10, wherein the deriving the plurality of interim frames within the preset duration based on the current frame and the starting frame comprises:
acquiring dimension parameters in the current frame;
acquiring dimension parameters in the starting frame;
comparing the dimension parameters in the current frame with the dimension parameters in the starting frame to record parameters that are different in the current frame and the starting frame;
constructing key frames corresponding to the parameters that are different in the current frame and the starting frame;
inserting the key frames between the current frame and the starting frame; and
creating the interim frames among the key frames based on the preset duration and a frame rate of the expression animation of the current expression.

12. The smart terminal of claim 11, wherein a number of the interim frames is derived by the preset duration and a frame rate of the expression animation of the current expression.

13. The smart terminal of claim 11, wherein the key frames are constructed in a uniform manner.

14. The smart terminal of claim 11, wherein the dimension parameters comprise a shape parameter, a color parameter, a transparent parameter, a position parameter, and a scale parameter of an expression element of the expression animation.

15. The smart terminal of claim 9, after the play process of the current expression is interrupted, further comprising:
stopping the play process of the current expression.

16. The smart terminal of claim 9, wherein the determining whether the play process of a current expression is interrupted comprises:
acquiring a current frame of an expression animation of the current expression at an interruption time where the play process of the current expression is interrupted;
acquiring an end frame of the expression animation of the current expression;
detecting whether the current frame is same to the end frame; and
deciding the play process of the current expression is interrupted when the current frame is not same to the end frame, otherwise deciding the play process of the current expression is uninterrupted.

17. A non-transitory computer readable medium, storing computer programs, wherein the computer programs, when executed by a processor, cause the processor to perform a method for switching expression of a smart terminal, the smart terminal displaying different expression animations to express different expressions, and the method comprising:
determining whether a play process of a current expression is interrupted when receiving a request for expression conversion; and
deriving interim data based on the current expression and a request expression, and playing the request expression after rendering the interim data when the play process of the current expression is interrupted; otherwise, playing the request expression directly.
